(19) United States
(12) Patent Application Publication
(10) Pub. No.: US 2002/0023917 A1
(43) Pub. Date: Feb. 28, 2002

(54) Decorative heating pad

(76) Inventor: Mary Hall-Grace, Edwardsville, KS (US)

Correspondence Address: HOVEY, WILLIAMS,TIMMONS & COLLINS, 2405 Grand, Suite 400, Kansas City, MO, 64108, US

(21) Appl. No.: 09/942,282

(22) Filed: Aug. 27, 2001

Related U.S. Application Data
(60) Provisional application No. 60/229,200, filed on Aug. 30, 2000.

(51) Int. Cl. H05B 3/34

(52) U.S. Cl. 219/528; 219/549; 219/201

(57) ABSTRACT

A decorative heating pad assembly (10) is provided which includes a main body (12) in the form of a stylized mock animal such as a manatee. The assembly (10) has stitched-together top and bottom walls (24, 26) with soft, pliable fill (29), and presents a trunk or primary section (18) together with appendages such as head (20) and flippers (22). A fabric panel (14) is secured to the bottom wall (26) to form a pocket (44) adapted to receive a heating pad (46). The pocket (44) is configured so that a user's hand and forearm (A) can be inserted within the pocket (44) between the pad (46) and bottom wall (26). A variety of stylized animal configurations can be used, such as a manatee, turtle, bear, beaver, dog and cat.

### RELATED APPLICATION

This Application claims benefit from the Provisional Patent Application Ser. No. 60/229,200, filed Aug. 30, 2000, the teachings of which are incorporated herein by reference.

### BACKGROUND OF THE INVENTION

1. Field of the Invention

The present invention is broadly concerned with decorative and comforting heating pad assemblies especially designed for use by older adults or children. More particularly, the invention pertains to heating pad assemblies including a main body in the form of a stylized mock animal having a bottom pocket adapted to receive a heating pad and permitting the user's hand and arm to be inserted within the pocket.

2. Description of the Prior Art

Conventional heating pads generally comprise a fabric cover with a flat, normally rectangular resistance-type heating element within the cover. These units are usually controlled by an electrical rheostat or similar device in order to maintain a desired temperature. Heating pads of this type are commonly used by senior citizens during cold weather, or as a comforting heat therapy for arthritic joints and the like. Also, many children enjoy the warmth and comfort of heating pads when they are ill.

While heating pads of this type have long been available, they are entirely utilitarian and totally lacking in aesthetic appeal. Moreover, use of these heating pads is instantly recognizable, owing to the fact that there is generally no decorative element associated with the pads.

### SUMMARY OF THE INVENTION

The present invention overcomes the problems outlined above and provides heating pad assemblies which are not only highly functional, but which meet the desires of many older individuals and children for amusing and decorative designs. Broadly speaking, the pad assemblies include a main body in the form of a stylized mock animal (e.g., manatee, turtle, bear, beaver, dog or cat) including a top and bottom wall with soft, pliable internal fill. Also, a panel is secured to the underside of the main body to define a pocket which receives an electrical heating pad. The pocket is designed so as to permit insertion of a user's hand and forearm, if desired. The assembly may be easily positioned by the user for the desired application of heat to individual body parts.

Preferably, the outer surface of the main body is made up of a fleece or other soft fabric colored to correspond with the mock animal motif. Thus, a manatee design would include green fabric as the top wall thereof.

### BRIEF DESCRIPTION OF THE DRAWINGS

FIG. 1 is a top perspective view of a heating pad assembly in accordance with the invention;

FIG. 2 is a bottom perspective view thereof, with the pocket-forming panel partially broken away;

FIG. 3 is a bottom perspective view illustrating the opposite end of the assembly as compared with FIG. 2, and depicting the fill access opening; and

FIG. 4 is a sectional view illustrating use of the assembly with a user's hand and forearm inserted between the heating pad and bottom wall of the main body.

### DETAILED DESCRIPTION OF THE PREFERRED EMBODIMENT

Turning now to the drawings, a heating pad assembly 10 in accordance with the invention, broadly includes a main body 12, a bottom panel 14 secured to the underside of the body 12, and an electrical resistance type heating pad 16 inserted between the panel 14 and main body 12.

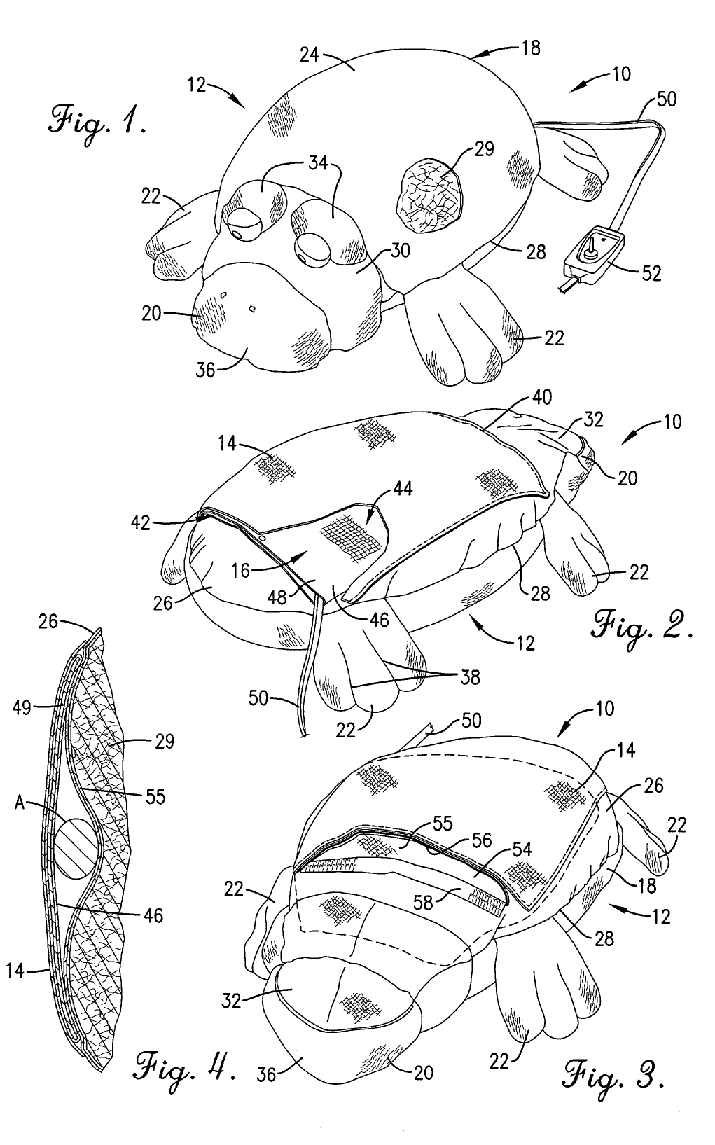

In more detail, it will be observed that the main body is in the form of a stylized mock manatee and presents a generally rounded, bulbous trunk or primary section 18, and appendages in the form of a head 20 and flippers 22 secured to the section 18. As best seen in FIGS. 1 and 2, the section 18 is made up of a soft fabric (e.g., green-colored fleece) top wall 24 and a cotton fabric bottom wall 26. The head 20 is in effect a continuation of the section 18, with a green-colored fleece upper fabric wall 30, and a cotton underside 32. The walls 24, 26 and the extensions 30,32 thereof are stitched along line 28. The head 20 is equipped with enlarged eyes 34 as well as a simulated snout 36. The flippers 22 are formed entirely of the green fleece material and include stitch lines 38 to partition the flippers. As shown, the flippers are sewn to the main body 12 generally along the area of stitch line 28.

In order to achieve the desired three-dimensional shape, the main body 12 is filled with a soft, pliable fill 29 which fills both primary section 18 and head 20. the maximum thickness of the main body should be at least 1½ inches, and more preferably fro about 2-6 inches. The flippers on the other hand are separately filled with similar material.

The bottom panel 14 is also formed of fabric, preferably a cotton or flannel type. The panel is generally rectangular in shape and is stitched to bottom wall 26 along stitch line 40 extending throughout three margins thereof leaving an open margin 42. Thus, the panel 14 and bottom wall 26 cooperatively define a pocket 44.

An electrical heating pad 46 is located within pocket 44 and includes a fabric cover 48 with an internal, electrical resistance heating element 49 of conventional design. An electrical cord 50 extends from the cover 48 and has a typical heater control 52 interposed therein. The pad 46 is usually controlled to operate at a safe range of from about 90-120° F.

Referring now to FIG. 4, it will be observed that there is sufficient clearance within pocket 44 between heating pad 46 and bottom wall 26 to permit insertion of a user's hand and forearm A. Of course, the soft, pliable nature of the main body 12 also accommodates the user's hand and forearm.

Referring to FIG. 3, it will be observed that the bottom wall 26 is provided with an opening 54 generally at the region between primary section 18 and head 20, with a section of fabric 55 between the inner face of bottom wall 26 and the fill to prevent unadvertent spill-out of the fill 29. A pair of mating Velcro strips 56, 58 are sewn to opposed margins of the opening 54, so that the opening may be selectively closed. However, when opened, the fabric 55 and fill material 29 may be removed from the assembly to facilitate cleaning thereof.

The invention will have particular utility with older adults who appreciate the warmth from a heating pad and also find amusing the stylized mock animal motif of the assembly.

I claim:

1. A heating pad assembly comprising:
a main body in the form of a stylized mock animal and presenting a top wall, a bottom wall, and soft, pliable fill material between the top and bottom walls;
a panel secured to said main body bottom wall to cooperatively define a pocket between the panel and bottom wall, with at least one open margin;
an electrical heating pad located within said pocket,
there being sufficient clearance between said pad and body bottom wall to allow insertion of a user's hand and forearm therebetween.

2. The assembly of claim 1, said panel formed of soft fabric stitched to said bottom wall.

3. The assembly of claim 1, said main body having a maximum thickness of at least about 1½ inches.

4. The assembly of claim 3, said thickness being from about 2-6 inches.

5. The assembly of claim 1, said main body in the form of a stylized mock animal selected from the group consisting of a manatee, turtle, bear, beaver, dog and cat.

6. The assembly of claim 1, said main body including projecting appendages simulating the head and limbs of said mock animal.

7. The assembly of claim 1, including a selectively openable access passageway permitting removal of said fill material from said main body.

8. The assembly of claim 1, said top wall made of a soft fleece material.

9. The assembly of claim 1, said top and bottom walls being stitched together.

10. The assembly of claim 1, said panel being generally rectangular and stitched to said bottom wall along three of the margins thereof, thereby leaving the unstitched margin open.

11. A heating pad assembly comprising:
a main body in the form of a stylized mock animal and presenting a top wall, a bottom wall, and soft, pliable fill material between the top and bottom walls;
a panel secured to said main body bottom wall to cooperatively define a pocket between the panel and bottom wall, with at least one open margin; and
an electrical heating pad located within said pocket.

12. The assembly of claim 11, said panel formed of soft fabric stitched to said bottom wall.

13. The assembly of claim 11, said main body having a maximum thickness of at least about 1½ inches.

14. The assembly of claim 13, said thickness being from about 2-6 inches.

15. The assembly of claim 11, said main body in the form of a stylized mock animal selected from the group consisting of a manatee, turtle, bear, beaver, dog and cat.

16. The assembly of claim 11, said main body including projecting appendages simulating the head and limbs of said mock animal.

17. The assembly of claim 11, including a selectively openable access passageway permitting removal of said fill material from said main body.

18. The assembly of claim 11, said top wall made of a soft fleece material.

19. The assembly of claim 11, said top and bottom walls being stitched together.

20. The assembly of claim 11, said panel being generally rectangular and stitched to said bottom wall along three of the margins thereof, thereby leaving the unstitched margin open.
